(19) United States
(12) Patent Application Publication
(10) Pub. No.: US 2020/0311820 A1
(43) Pub. Date: Oct. 1, 2020

(54) HOMELESSNESS INSURANCE AND A METHOD THEREFOR

(71) Applicant: RESSURRECTION GRAVES, DUMFRIES, VA (US)

(72) Inventor: RESSURRECTION GRAVES, DUMFRIES, VA (US)

(21) Appl. No.: 16/363,291

(22) Filed: Mar. 25, 2019

(51) Int. Cl. G06Q 40/08; G06Q 40/02

(52) U.S. Cl. CPC G06Q 40/08; G06Q 40/025

(57) ABSTRACT

This invention provides insurance protection against homelessness. In particular, the invention calculates a homelessness quotient for a member based upon several key factors and then uses it to provide an insurance policy whether a member is at high risk or at low risk for homelessness based upon present and pre-existing conditions experienced by the member.

### FIELD OF THE INVENTION

This invention provides insurance protection against homelessness. In particular, the invention calculates a homelessness quotient for a member based upon several key factors and then uses it to provide an insurance policy whether a member is at high risk or at low risk for homelessness based upon present and pre-existing conditions experienced by the member.

### BACKGROUND OF THE INVENTION

Homelessness in developed countries like America is an ever increasing, ever widening problem. It cuts across all ages, genders, ethnicities and backgrounds. It tugs at the edges of all aspects of society and threatens to encroach in places of even the greatest prosperity.

It is also largely predictable. There are critical factors that most of the homeless population has in common. Some of these include pre-existing health, debt loads, job security and more. Social scientists have long been able to cull like characteristics of homeless populations in various cities and rural locales.

There does not exist a comprehensive solution to homelessness, however. What is needed is a way not only to predict homelessness down to the individual but also provide a way to prevent it, limit it or escape it altogether. At present, such a method or system does not exist.

What is needed is a solution that eliminates homelessness, mitigates against it, and/or prevents it. This solution and the particulars of its implementation are discussed at length in this application.

### SUMMARY OF THE INVENTION

Accordingly, the invention provides a method of preventing homelessness. It comprises:

Identifying an eligible insurable pool;
a. Analyzing the eligible insurable pool to determine each member's eligibility within the pool;
b. Calculating a homelessness quotient for the eligible insurable pool;
c. Applying the homelessness quotient to each member within the eligible insurable pool;
d. Assigning a homelessness quotient to each said eligible member within the eligible insurable pool;
e. Creating an insurance risk pool for each member achieving homelessness quotient; and
f. Providing insurance that mitigates against homelessness for each member in the insurance risk pool.

One of the key criteria used to calculate the homelessness quotient is a member's entire credit profile which includes a member's credit rating amongst multiple other credit related criteria. Eligible credit ratings for consideration therein range from about 350 to about 650. They may also range from about 400 to about 600. Another such criteria is the average salary of a member. Eligible average salaries for consideration are less than about one-hundred thousand dollars, less than about seventy-five thousand dollars, less than about fifty thousand dollars or less than about twenty-five thousand dollars. Importantly, the actual salary of each subject member is also used as part of the calculation in the homelessness quotient.

Another key criteria used to calculate the homelessness quotient a member's net worth. Eligible net worth for consideration is less than about one-hundred thousand dollars, or less than about seventy-five thousand dollars, or less than about fifty thousand dollars or less than about twenty-five thousand dollars. An additional criteria used to calculate the homelessness quotient is a member's average debt load. Eligible debt load for consideration is one of at least seventy percent, at least fifty percent, or at least thirty-five percent. In an alternate version of the homelessness quotient calculation herein, the HQ may be calculated in which a member has an unlimited cap on salary.

A member's student loan debt is another criteria for use in the analysis of a member's homelessness quotient. Eligible student loan for consideration is at least one-hundred thousand dollars, at least seventy-five thousand dollars, or at least fifty thousand dollars.

In all, the homelessness quotient may be calculated from a combination of a member's age, address, credit rating, state of employment, employment history, salary, net worth, debt load, student loan debt, level of education, military service, presence of pre-existing health or mental condition, kind of pre-existing health or mental condition, and religious affiliation, pre-existing exposure to poverty and/or homelessness. Additional criteria may be added as is necessary to effectively define the homelessness quotient.

### DETAILED DESCRIPTION OF THE INVENTION

By the term “debt load” or “eligible debt load”, it is meant herein the total percentage of a member's debt as compared to the member's total monthly received income.

By the term “student debt load”, it is meant herein the percentage that a member's student loan debt is in comparison to the member's total monthly received income.

By the term “pre-existing health or mental condition”, it is meant herein a verifiable physical or mental health condition that a member has before consideration for coverage by the described homelessness insurance herein.

By the term “homelessness insurance”, it is meant a monetary guarantee of compensation for specified losses, damage, illnesses (i.e., catastrophic losses) that can lead to a member or member's family becoming homeless as a direct result of a one or more catastrophic losses.

By the term “Homelessness Quotient (HQ)”, it is meant herein the factor by which a person or a demographic of persons are assessed for the probability of homelessness over a given time period, e.g., five years, 10 years, lifetime.

The invention herein provides a method of preventing homelessness. It comprises the following:

Identifying an eligible insurable pool;
a. Analyzing the eligible insurable pool to determine each member's eligibility within the pool;
b. Calculating a homelessness quotient for the eligible insurable pool;
c. Applying the homelessness quotient to each member within the eligible insurable pool;
d. Assigning a homelessness quotient to each said eligible member within the eligible insurable pool;
e. Creating an insurance risk pool for each member achieving homelessness quotient; and
f. Providing insurance that mitigates against homelessness for each member in the insurance risk pool.

One of the key criteria used to calculate the homelessness quotient is a member's credit rating. Eligible credit ratings for consideration therein range from about 300 to about 900. They may also range from about 400 to about 600. Another such criteria is the average salary of a member. Eligible average salaries for consideration are less than about one-hundred thousand dollars, less than about seventy-five thousand dollars, less than about fifty thousand dollars or less than about twenty-five thousand dollars or a limitless salary cap.

Another key criteria used to calculate the homelessness quotient a member's net worth. Eligible net worth for consideration is less than one-hundred thousand dollars less than seventy-five thousand dollars, less than fifty thousand dollars or less than twenty-five thousand dollars. An additional criteria used to calculate the homelessness quotient is a member's average debt load. Eligible debt load for consideration is one of at least seventy percent, at least fifty percent, or at least thirty-five percent.

A member's student loan debt is another criteria for use in the analysis of a member's homelessness quotient. Eligible student loan for consideration is at least one-hundred thousand dollars, at least seventy-five thousand dollars, or at least fifty thousand dollars.

In all, the homelessness quotient may be calculated from a combination of a member's age, address, credit rating, state of employment, employment history, salary, net worth, debt load, student loan debt, level of education, military service history, active military service, presence of pre-existing health or mental condition, kind of pre-existing health or mental condition, group demographic information, work history, financial education, multi-generational socio-economic data (e.g., history of poverty, wealth), number of income streams, current number of jobs, history of homelessness, history of abuse and religious affiliation, if any.

Each of the above factors may be included in the calculation of the homelessness quotient (HQ). Also, no more than five of the above factors may be included and/or no more than ten of the above factors may be included. The practitioner has flexibility and may use the five or more factors noted hereinabove to calculate the HQ depending upon the location, size, type and membership of a would-be insurance pool. Persons of skill in the art will readily recognize the designability of the HQ and customize same as is necessary and desired.

The HQ is used in the overall method to issue insurance to mitigate against homelessness, prevent it or cure it. In practice, each of the factors is given a weighted score. The sum of the scores is taken to provide a Homelessness Number (HN). The HN is then weighted by a separate Homelessness Factor (HF) to produce a Raw Homelessness Quotient (RHQ). Once weighted, an algorithm is applied to the HN to form the final HQ, i.e., the Homelessness Quotient. The following EXAMPLES are exemplary.

### Example I

### Questionnaire—Homeless Risk Assessment (HRA)

This is an example questionnaire for a prospective client for homelessness:

### Example II

As noted hereinabove, an algorithm is then applied to the Raw Homelessness Quotient (RHQ) to produce the final Homelessness Quotient.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of preventing homelessness, comprising:
a. Identifying an eligible insurable pool;
b. Analyzing said eligible insurable pool to determine its eligibility;
c. Calculating a homelessness quotient for said eligible insurable pool;
d. Applying said homelessness quotient to each member within said eligible insurable pool;
e. Assigning a homelessness quotient to each said eligible member within said eligible insurable pool;
f. Creating an insurance risk pool for each said member achieving said homelessness quotient; and
g. Providing insurance that mitigates against homelessness for each said member in said insurance risk pool.

2. The method of claim 1 wherein said eligible insurable pool comprises a credit rating ranging from about 350 to about 650.

3. The method claim 2 wherein said eligible insurable pool comprises a credit rating ranging from about 400 to about 600.

4. The method of claim 1 wherein said eligible insurable pool comprises an average salary of less than about one-hundred thousand dollars.

5. The method of claim 4 wherein said eligible insurable pool comprises an average salary of less than about seventy-five thousand dollars.

6. The method of claim 5 wherein said eligible insurable pool comprises an average salary of less than about fifty thousand dollars.

7. The method of claim 6 wherein said eligible insurable pool comprises an average salary of less than about twenty-five thousand dollars.

8. The method of claim 1 wherein said eligible insurable pool comprises a net worth of less than one-hundred thousand dollars.

9. The method of claim 8 wherein said eligible insurable pool comprises a net worth of less than seventy-five thousand dollars.

10. The method of claim 9 wherein said eligible insurable pool comprises a net worth of less than fifty thousand dollars.

11. The method of claim 10 wherein said eligible insurable pool comprises a net worth of less than twenty-five thousand dollars.

12. The method of claim 1 wherein said eligible insurable pool comprises an average debt load of at least seventy percent.

13. The method of claim 12 wherein said eligible insurable pool comprises an average debt load of at least fifty percent.

14. The method of claim 13 wherein said eligible insurable pool comprises an average debt load of at least thirty-five percent.

15. The method of claim 1 wherein said eligible pool comprises an average student loan debt of at least one-hundred thousand dollars.

16. The method of claim 15 wherein said eligible pool comprises an average student loan debt of at least seventy-five thousand dollars.

17. The method of claim 16 wherein said eligible pool comprises an average student loan debt of at least fifty thousand dollars.

18. The method of claim 1 wherein said homelessness quotient is calculated from a combination of a member's age, address, credit rating, state of employment, employment history, salary, net worth, debt load, student loan debt, level of education, military service, presence of pre-existing health or mental condition, and kind of pre-existing health or mental condition.

19. A method of assessing homelessness, comprising:
a. Identifying an eligible insurable pool;
b. Analyzing said eligible insurable pool to determine its eligibility; and
c. Calculating a homelessness quotient for said eligible insurable pool, said homelessness quotient having an algorithm assignable to pre-identified markers for homelessness within said eligible insurable pool.

20. The method of claim 20 wherein said homelessness quotient is calculated from a combination of a member's age, address, credit rating, state of employment, employment history, salary, net worth, debt load, student loan debt, level of education, military service, presence of pre-existing health or mental condition, and kind of pre-existing health or mental condition.
